(19) United States
(12) Patent Application Publication
(10) Pub. No.: US 2022/0076587 A1
(43) Pub. Date: Mar. 10, 2022

(54) A COMPUTER PROGRAM PRODUCT AND METHOD FOR TEACHING COMPUTER PROGRAMMING

(71) Applicant: Robotify Labs Limited, Glasnevin, Dublin 9 (IE)

(72) Inventors: Andrew Murphy, Terenure, Dublin (IE); Adam Dalton, Donaghmede, Dublin (IE); Evan Darcy, Kinsealy, Swords, Dublin (IE)

(21) Appl. No.: 17/420,015

(22) PCT Filed: Jan. 2, 2020
(86) PCT No.: PCT/EP2020/050043

§ 371 Date: Jun. 30, 2021

(30) Foreign Application Priority Data
Dec. 31, 2018 (GB) 1821322.3

(51) Int. Cl. G09B 19/00; G09B 5/06; G06F 8/34

(52) U.S. Cl. CPC G09B 19/0053; G06F 8/34; G09B 5/06

(57) ABSTRACT

This invention relates to a computer program product for teaching computer programming comprising program code for rendering a user interface on a user computing device. The user interface comprises a programming pane, a compiler and a video feed pane. The programming pane is operable to receive control commands from a user, the compiler is operable to compile the control commands and the video feed pane comprises a robot emulator and a background, both for display simultaneously in the video feed pane. The robot emulator is operable to move the robot relative to the background in the video feed pane. This gives the impression to the user that they are operating a robot. Purchase of a physical robot is not needed by the user while they derive the majority of the benefits of learning to program with a robot.

### TECHNICAL FIELD

This invention relates to a computer program product and a computer-implemented method for teaching computer programming.

### BACKGROUND ART

The importance of computer programming skills in modern society has increased to the point where computer programming skills are being taught to children as young as eight years old. In some primary/elementary schools, computer programming is now taught as part of the syllabus.

However, as with many subjects that are often perceived as difficult or demanding, it can often prove challenging for teachers to engender an affection for the subject in their students. Furthermore, it can often prove difficult to achieve high knowledge retention rates amongst the students. In order to more comprehensively engage the students and make learning computer programming more enjoyable, it has been proposed to use programmable robots as part of the learning process. The students effectively learn to program by programming instructions which translate into actions for the robot to perform. This has been found to facilitate knowledge retention and improve student engagement. It is believed that one such system is that disclosed in Chinese Published Patent Application No. CN107479417 in the name of Taizhou Jiangnan Teaching Equipment Co Ltd, whereby students can learn to program by programming a robot to perform certain actions.

Although the system described in CN107479417 offers a significant improvement over other known systems and methods for teaching computer programming skills, there are however problems with that offering. First of all, it is relatively expensive to purchase the robot. School budgets are already under pressure and additional capital expenditure on what are perceived as luxury or non-essential items are hard to justify. If class sizes are of the order of 30 students per class, it would typically be prohibitively expensive to purchase a robot for each child in the class. In some cases, a smaller number of robots may be purchased and the children can work in groups however this reduces the amount of time that each of the students has to work individually with the robot and practice their programming.

Secondly, the robots must be safely stored when not in use and this takes up valuable storage space in the school. Thirdly, the robots must be maintained, and their batteries replaced frequently and this introduces additional work for the staff. Fourth, if a robot should break down for any reason, for example through normal wear and tear, it must be returned to the manufacturer or a trusted third party for repair and this further reduces the amount of time that the robot is available to the students. Finally, the students are restricted as to when they may practice their programming skills with the robot. Typically, students would not be allowed to bring the robot home with them and therefore access will be further restricted to school hours. This can frustrate the enthusiasm of a student to practice their skills and perfect their knowledge.

It is an object of the present invention to provide a computer program product and a computer-implemented method for teaching computer programming that overcomes at least one of the above-identified problems and that offers a useful choice to the consumer.

### SUMMARY OF INVENTION

According to the invention there is provided a computer program product for teaching computer programming comprising program code for rendering a user interface on a user computing device, the user interface comprising a programming pane, a compiler and a video feed pane;
the programming pane being operable to receive control commands from a user;
the compiler being operable to compile the control commands received in the programming pane and pass those compiled control commands to the video pane; and
the video feed pane comprising a robot emulator and a background, both for display in the video feed pane.

By having such a computer program product, it will not be necessary to provide every student or indeed any student with a physical robot. The school will not have to incur the costs of robot purchase and maintenance, and the school will also not have the inconvenience of storing several robots on site. Instead, the students will view on their computing device footage of a robot performing the steps that they programmed the robot to perform. This will provide the student with all the advantages of seeing their programming being actioned by a robot without the student having to have access to a physical robot.

Furthermore, by providing such a computer program product, the student will not be constrained to working on the robot during school hours and they may practice their programming at other times during the day or night or at weekends. Advantageously, instead of providing a live video feed of an actual robot located remotely that may be used by multiple students at different times during the day, the students will instead be presented with a realistic simulation of a robot performing programmed operations on their computing device. This obviates the need for high bandwidth use and reliable connection to transmit a video feed from a remote robot to the student's computing device and significantly reduces communication overhead. It further avoids scheduling conflicts, organisational overhead and any problems associated with latency or lag from the time of instruction to the time of execution to the time of delivering the video feed back to the user computing device.

In one embodiment of the invention there is provided a computer program product in which the robot emulator for display in the video feed pane comprises a three-dimensional (3D) simulation of the robot.

In one embodiment of the invention there is provided a computer program product in which the background for display in the video feed pane comprises a three-dimensional (3D) simulation of the background.

In one embodiment of the invention there is provided a computer program product in which the robot emulator uses a JavaScript port and a physics engine. In one embodiment of the invention there is provided a computer program product in which the JavaScript port is Ammo.js and the physics engine is Bullet physics engine.

In one embodiment of the invention there is provided a computer program product in which the video feed pane comprising a robot emulator having at least one video of a robot performing a manoeuvre, and the background, both for display in the video feed pane; the robot emulator being operable to execute the compiled control commands by displaying the background in the video pane, playing the video of the robot performing the manoeuvre on the background, and moving the video of the robot relative to the background in the video feed pane.

By using previously captured video footage of the robot performing certain actions, when the student instructs the robot to perform those actions, an appropriate video file is used to simulate those actions and shown to the student in real time. To all intents and purposes, it will appear to the student as though they are instructing an actual physical robot in real time however in actuality, they are viewing a previously stored video file of a robot performing the task that they instructed it to do.

In one embodiment of the invention there is provided a computer program product in which the robot emulator comprises a library of videos of a robot performing a plurality of disparate manoeuvres. In this way, a number of videos may be provided which will enhance the user's experience. For example, in the case of a wheeled robot turning, the wheels will turn in different directions depending on whether or not the robot is turning clockwise or anti-clockwise. By providing a plurality of videos, the appropriate video for the robot action is selected and a more realistic user experience may be provided. Furthermore, by having a library of videos, the functionality of the robot and what the student can program it to do will be enhanced.

In one embodiment of the invention there is provided a computer program product in which the library of videos comprises: (i) a video of the robot moving forwards; (ii) a video of the robot moving backwards; (iii) a video of the robot stationary; (iv) a video of the robot turning clockwise; and (v) a video of the robot turning counter-clockwise. This is seen as a simple and effective library of videos to provide and will enable the computer program product to deliver a realistic experience of a robot driving around a designated area.

In one embodiment of the invention there is provided a computer program product in which the background is a video of a background and the robot emulator is operable to superimpose the video of the robot performing a manoeuvre on top of the video of the background in the video pane. This is seen as a simple yet effective way to provide a realistic experience for the end user. By using a video of a background rather than a static or coloured background, a more realistic video will be delivered to the student thereby enhancing their user experience. The two video feeds may be spliced together with the video feed of the robot superimposed onto the video of the background.

In one embodiment of the invention there is provided a computer program product in which the background is provided with a border operable to contain the video of the robot therein. This is seen as an advantageous way of providing a realistic experience to the end user. By implementing a border on the background video, the video of the robot can be contained within that border, thereby obviating the possibility of the robot video moving to a location that would in real terms be impossible (e.g. the video of the robot cannot be shown to pass through a wall on the background video or move off the screen altogether).

In one embodiment of the invention there is provided a computer program product in which the robot emulator uses a transform operation to move the video of the robot relative to the background. This is seen as a simple and effective way of moving the robot video on the screen, giving the appearance that the robot is moving whereas the video of the robot is being moved in position about the video feed pane on the screen of the user computing device.

In one embodiment of the invention there is provided a computer program product in which the robot emulator uses a Cascading Style Sheets (CSS) transform to move the robot video relative to the background. Again, this is seen as a simple way of causing the robot to appear to move across the video feed pane in response to the users program instructions. For example, the user may instruct the robot to move forward by 10 centimeters (0.1 m). In order to perform this operation, a video of the robot with the wheels moving in an orientation that would appear to cause the robot to move forwards is displayed in the last known location of the robot and then a CSS transform is used to actually progress that video of the robot across the screen by a distance corresponding to a movement of the robot by 10 centimeters (0.1 m) in it's pod. Once the robot reaches its destination, another video of the robot in a stationary position (i.e. with the wheels no longer moving) will be played instead of the video of the robot with the wheels moving.

In one embodiment of the invention there is provided a computer program product in which the user interface comprises a web page. This is seen as a particularly effective way of delivering the offering to the end user. The end user, in this case a student, accesses a web page that will have the programming pane, the video feed pane and the compiler integrated therein. This will allow the use of CSS transforms and other programming techniques to implement the invention and the student will be able to access the site at a time and day of their choosing, providing that they have an internet connection. This implementation will enable the provider of the computer program product to update the user interface and the video libraries at will and will enable them to control access to the offering.

In one embodiment of the invention there is provided a computer program product in which the user interface comprises a tutorial pane, the tutorial pane having user instructions for performing a task. In this way, a teacher may supply the content of the tutorial pane, which may include instructions, hints, and/or parameters for the exercise thereby clearly setting the task for the student to perform. Advantageously, the student will have this as part of the interface along with their code in the programming pane and the video of the robot in the video feed pane.

In one embodiment of the invention there is provided a computer program product in which the user interface comprises a feedback pane, the feedback pane having an output comprising at least one of a compiled code and a commentary on the user-inputted control commands. This is seen as a particularly advantageous aspect of the invention as the student may see the actual syntactically correct code and compare it with the code that they have programmed. This will give them a feel for other representations of computer program code. Furthermore, the student may be provided with prompts, hints, tips, encouragement and/or feedback when they attempt to run their code.

In one embodiment of the invention there is provided a computer program product in which the programming pane comprises a Visual Programming Language (VPL) Editor. This is seen as a particularly useful way to teach young students how to program. The VPL editor will allow the student to program using “blocks” of code that may be combined together by the VPL editor. This simplifies many of the programming concepts for the student. Furthermore, it also reduces the emphasis on learning specific syntax pertaining to a programming language and allows the user to focus less on the syntax and more on the actual logic behind the code.

In one embodiment of the invention there is provided a computer program product in which the programming pane comprises a Blockly Editor. Alternatively, the programming pane comprises a Scratch Editor.

In one embodiment of the invention there is provided a computer program product in which the robot comprises a vehicle having a motor and at least two wheels driven by the motor.

In one embodiment of the invention there is provided a computer-implemented method of teaching computer programming comprising the steps of:
providing, on a user computing device a user interface having a plurality of panes including a programming pane and a video feed pane, the video feed pane comprising a robot emulator and a background, both for display in the video feed pane;
receiving, in the programming pane of the user interface of the user computing device a control command;
compiling the control command;
passing the compiled control command to the robot emulator;
the robot emulator executing the compiled control command by rendering the background and a robot performing a manoeuvre in front of the background in the video feed pane.

This is seen as a particularly useful computer-implemented method of teaching computer programming as it will allow the student to see the effects of their programming being carried out by a robot. This will enhance student engagement and facilitate student learning. Advantageously, the method obviates the need for each student to own or have access to a dedicated physical robot and instead the student will be presented with a realistic video of the robot performing the task that the student has instructed it to do. Furthermore, the processing is carried out on the client side rather than on the server side providing a more realistic user experience with less latency.

In one embodiment of the invention there is provided a computer implemented method in which the robot emulator for display in the video feed pane comprises a three-dimensional (3D) simulation of the robot.

In one embodiment of the invention there is provided a computer implemented method in which the background for display in the video feed pane comprises a three-dimensional (3D) simulation of the background.

In one embodiment of the invention there is provided a computer implemented method in which the step of rendering the background and the robot comprises using a JavaScript port and a physics engine to render the background and the robot.

In one embodiment of the invention there is provided a computer implemented method in which the JavaScript port is Ammo.js and the physics engine is Bullet physics engine.

In one embodiment of the invention there is provided a computer implemented method in which the robot emulator comprises at least one video of a robot performing a manoeuvre, and in which the step of the robot emulator executing the compiled control command comprises the step of the robot emulator rendering a video of a robot performing a manoeuvre in front of the background in the video feed pane and moving the video of the robot performing a manoeuvre relative to the background in the video feed pane.

In one embodiment of the invention there is provided a computer-implemented method in which the method comprises the intermediate step of the robot emulator selecting one of a plurality of videos of a robot performing a manoeuvre from a library of videos of the robot performing different manoeuvres. This is seen as a useful way of providing a more realistic end user experience and furthermore will broaden the functionality of the robot for the user, providing a more interactive, fun and immersive experience.

In one embodiment of the invention there is provided a computer-implemented method in which the intermediate step of the robot emulator selecting one of a plurality of videos of a robot performing a manoeuvre from a library of videos of the robot performing different manoeuvres comprises selecting one of (i) a video of the robot moving forwards; (ii) a video of the robot moving backwards; (iii) a video of the robot stationary; (iv) a video of the robot turning clockwise; and (v) a video of the robot turning counter-clockwise. It is envisaged that the above five videos are preferred to provide the most realistic end user experience however other videos could be provided as well or instead of these videos. For example, if the device is not a wheeled robot but instead a crane with a rotating boom and/or a hook or gripping device that may be moved vertically, videos of the various operations may be provided to simulate the operation of that robot.

In one embodiment of the invention there is provided a computer-implemented method in which the background is a video of a background and the method comprises the step of the robot emulator superimposing the video of the robot performing a manoeuvre on top of the video of the background in the video pane. Again, this will provide a more realistic experience for the end user. What is important in such an embodiment is that the end user actually believes that their instructions are manipulating a robot rather than a computer simulation of a robot and by providing a video background, the appearance of the offering will be more realistic for the end user.

In one embodiment of the invention there is provided a computer-implemented method in which the method comprises the step of rendering a background and a default video of a robot performing a manoeuvre in front of the background in the video feed pane while waiting for a control command. The default video may for example, be a video of a wheeled robot in a stationary position, with the wheels stationary but a flashing light on the robot indicating that it is awaiting an instruction.

In one embodiment of the invention there is provided a computer-implemented method in which the method comprises the initial step of defining a border for the background to delimit the movement of the video of the robot performing a manoeuvre in the video feed pane. This is seen as a simple way of restricting the movement of the first video and hence restricting the movement of the robot on the video feed pane. If the robot is allowed move to a portion of the screen that would be physically impossible, such as through a wall, this would dispel the belief of the student that they are operating a physical robot and be to the detriment of their enjoyment and engagement. The border is seen as a useful way of containing the video of the robot performing an action and providing the best experience to the end user.

In one embodiment of the invention there is provided a computer-implemented method in which the step of moving the video of the robot performing a manoeuvre relative to the background in the video feed pane comprises using a transform operation to move the robot video relative to the background. Again, this is seen as a simple and effective way of moving the video of the robot about the video feed pane. However, other methods of moving the video of the robot about the video feed pane are envisaged such as those used in some Javascript (Registered Trade Mark, ®) game frameworks. One example of a game framework that could be used to good effect to implement the movement of the video of the robot across the video feed pane is Phaser® which is a game framework for HTML5.

In one embodiment of the invention there is provided a computer-implemented method of teaching computer programming in which the step of providing a user interface comprises providing a web page to the user computing device. This is seen as a simple way of delivering the content to the end user however alternatively, a stand-alone program or “app” could be used to provide the user interface with the programming environment for the end user.

In one embodiment of the invention there is provided a computer-implemented method of teaching computer programming in which the step of: receiving, in the programming pane of the user interface of the user computing device a control command further comprises receiving a control command in a VPL.

In one embodiment of the invention there is provided a computer-implemented method of teaching computer programming in which the user interface comprises a tutorial pane and the method comprising the additional step of providing user instructions in the tutorial pane of the user interface.

In one embodiment of the invention there is provided a computer-implemented method of teaching computer programming in which the user interface comprises a feedback pane and the method comprising the additional step of providing at least one of compiled code and commentary on the user inputted control commands in the feedback pane of the user interface.

### BRIEF DESCRIPTION OF THE DRAWINGS

The invention will now be more clearly understood from the following description of some embodiments thereof given by way of example only with reference to the accompanying drawings, in which:—

FIG. 1 is a diagrammatic representation of a system in which the computer program product and computer-implemented method according to the invention may be implemented;

FIG. 2 is a diagrammatic representation of a physical robot that may be captured on video to form part of the product and method of the invention;

FIGS. 3(a) to 3(o) inclusive are screen shots of a user interface of the computer program product and computer-implemented method according to the invention;

FIGS. 4(a) to 4(c) inclusive are screen shots of a user interface of a second embodiment of the computer program product and computer-implemented method according to the invention; and

FIGS. 5(a) to 5(c) are screen shots of an enlarged video feed pane illustrating embodiments of the robot and background according to the second embodiment of the invention.

### DETAILED DESCRIPTION OF THE DRAWINGS

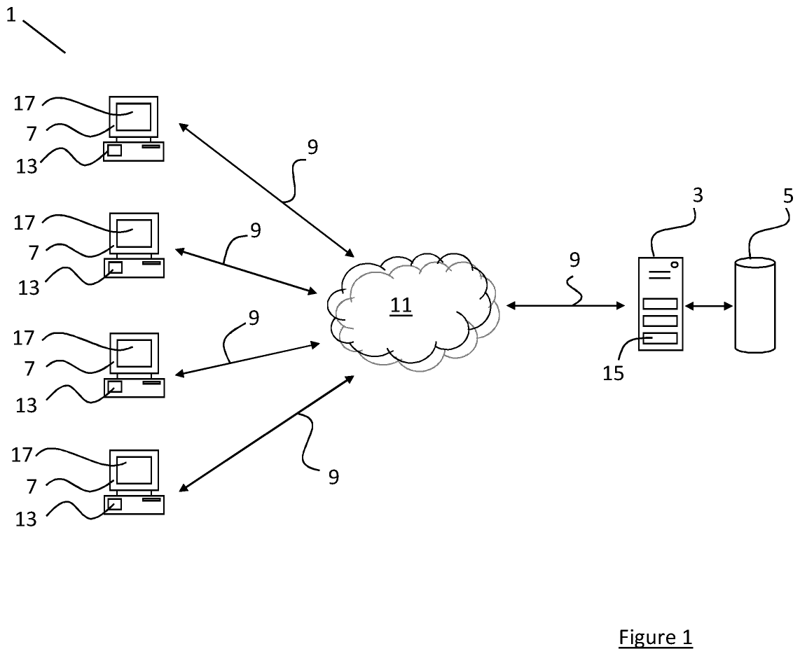

Referring to FIG. 1, there is shown a system for teaching computer programming in which the computer program product and computer implemented method according to the invention may be implemented, indicated generally by the reference numeral 1. The system 1 comprises a server 3 having an accessible memory 5 and a plurality of remote user computing devices 7. The remote user computing devices are in communication with the server over communication channels 9 routed through a communication network, in this case the internet 11.

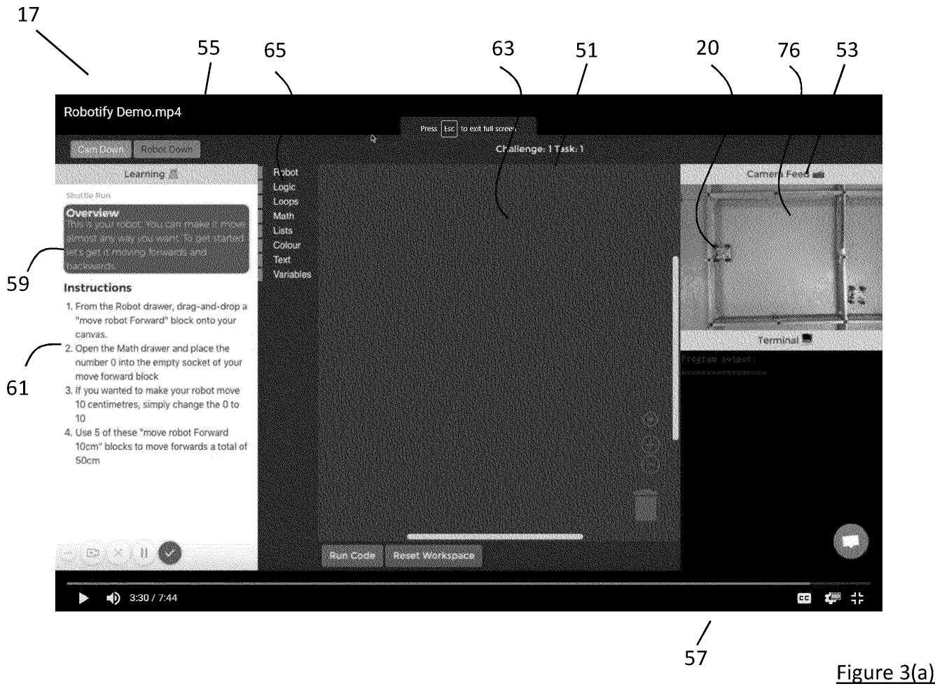

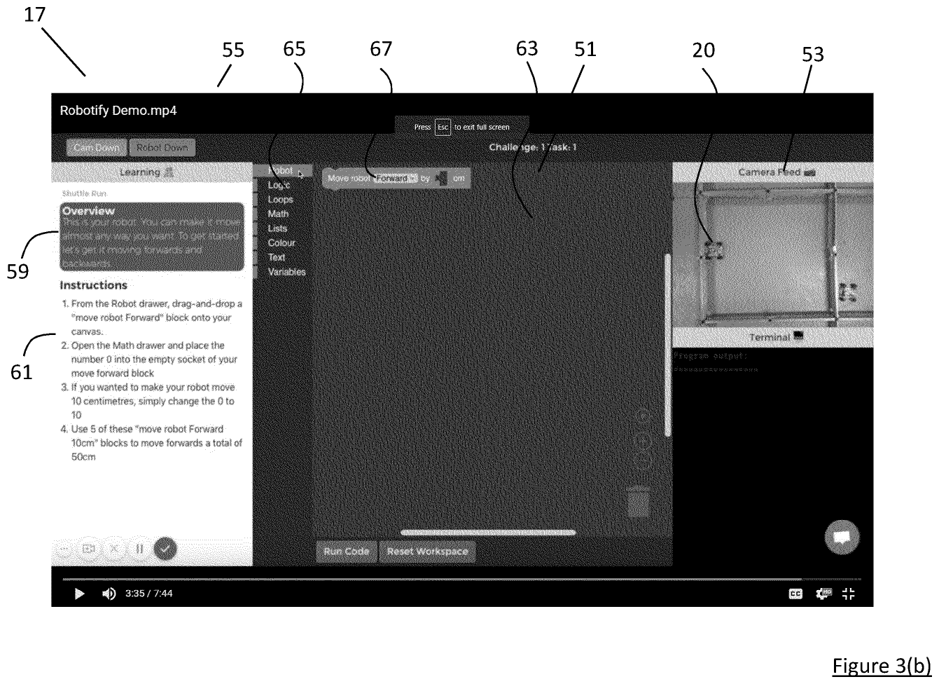

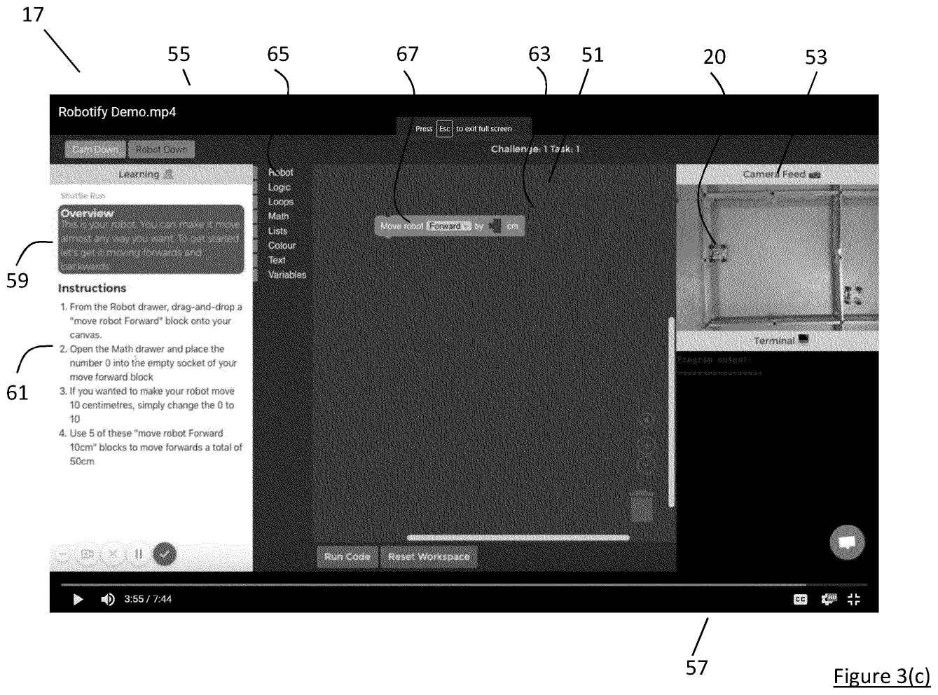

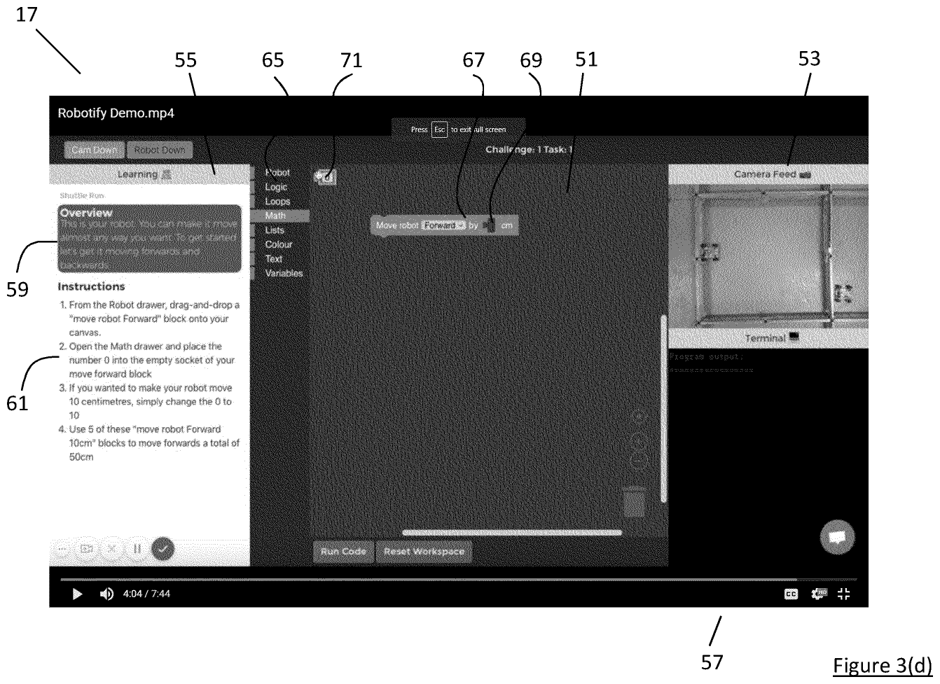

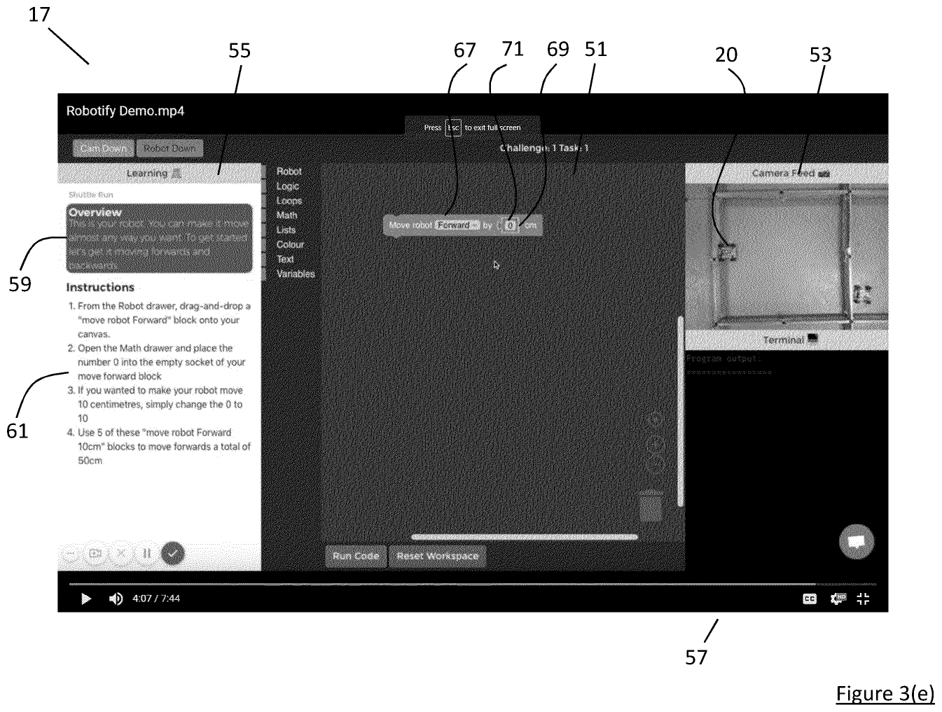

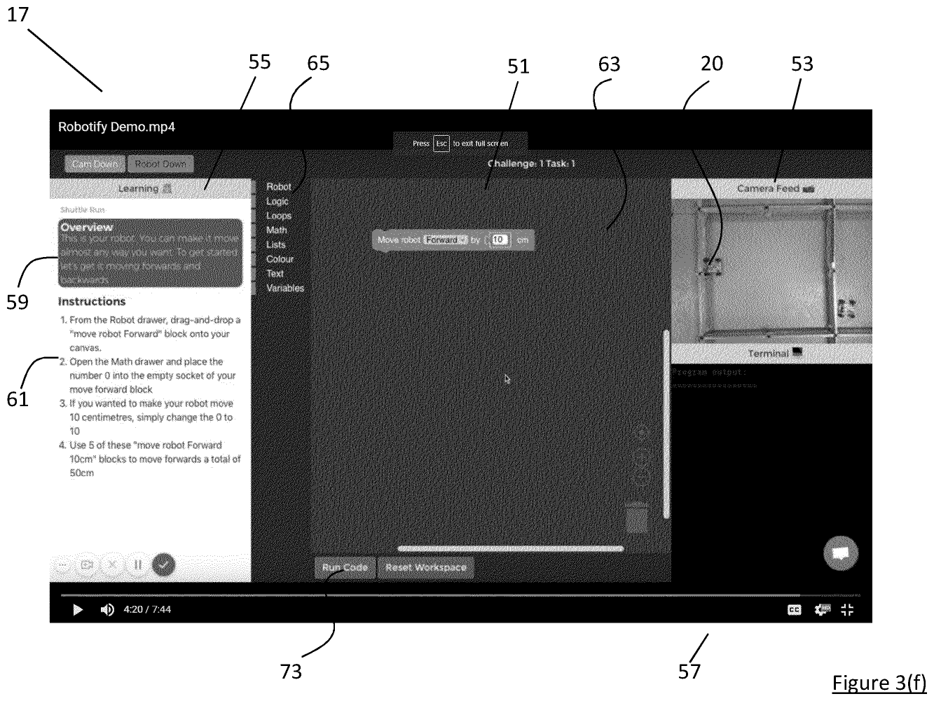

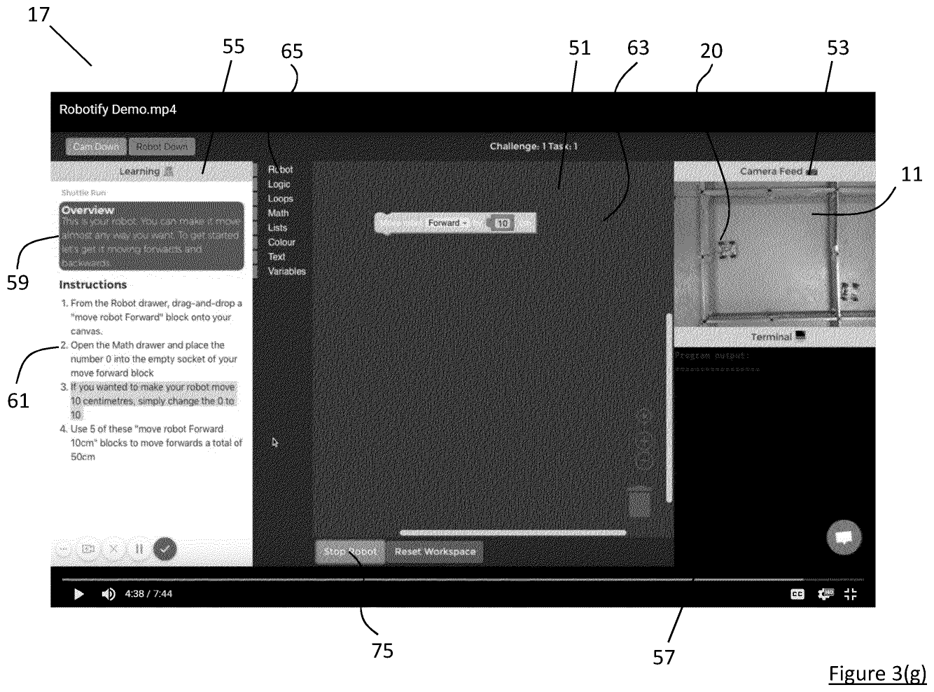

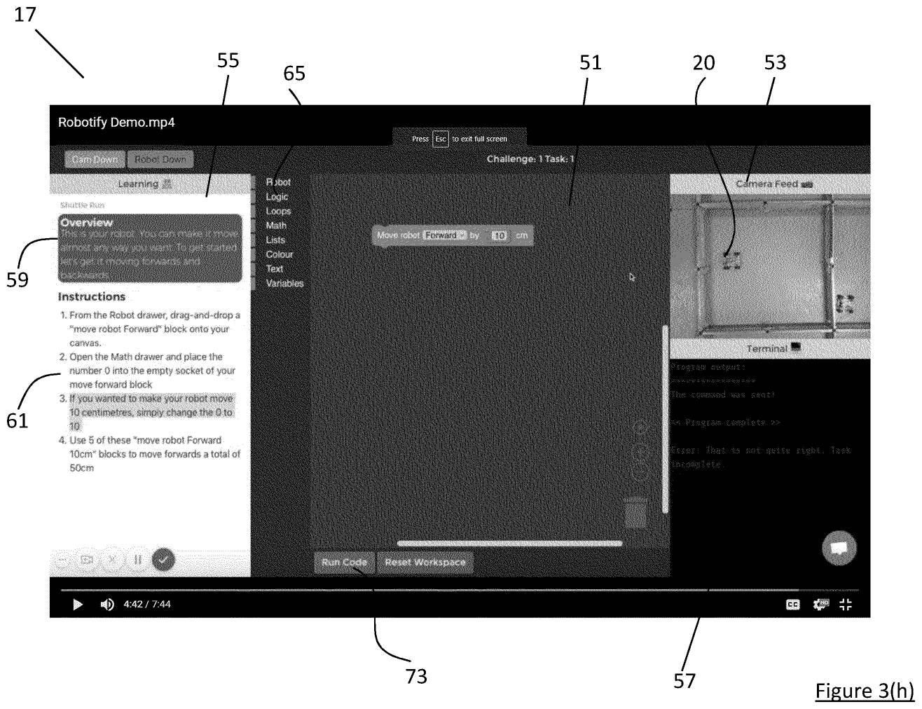

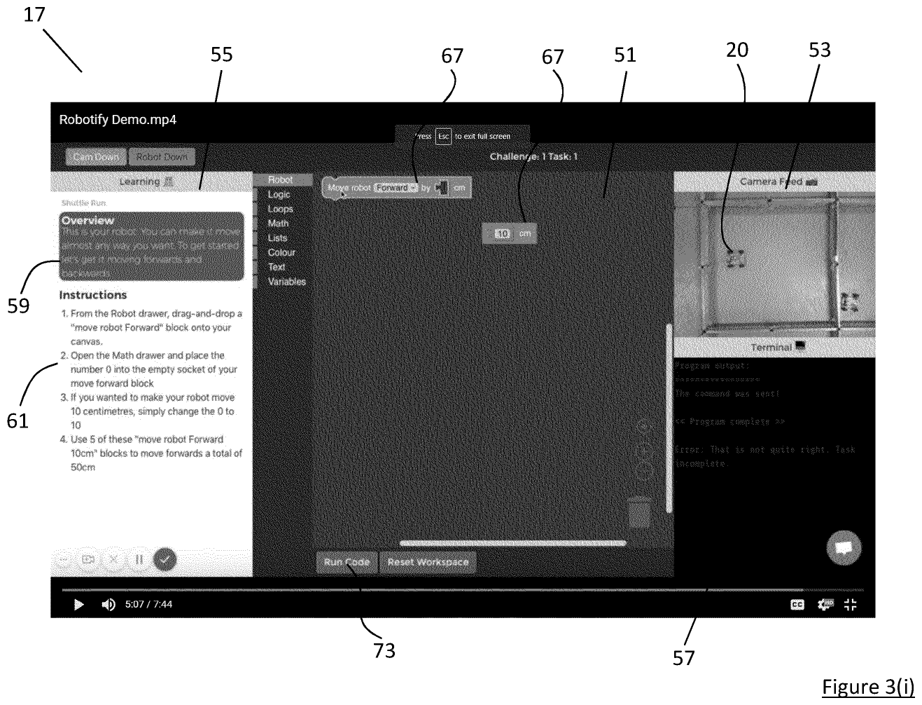

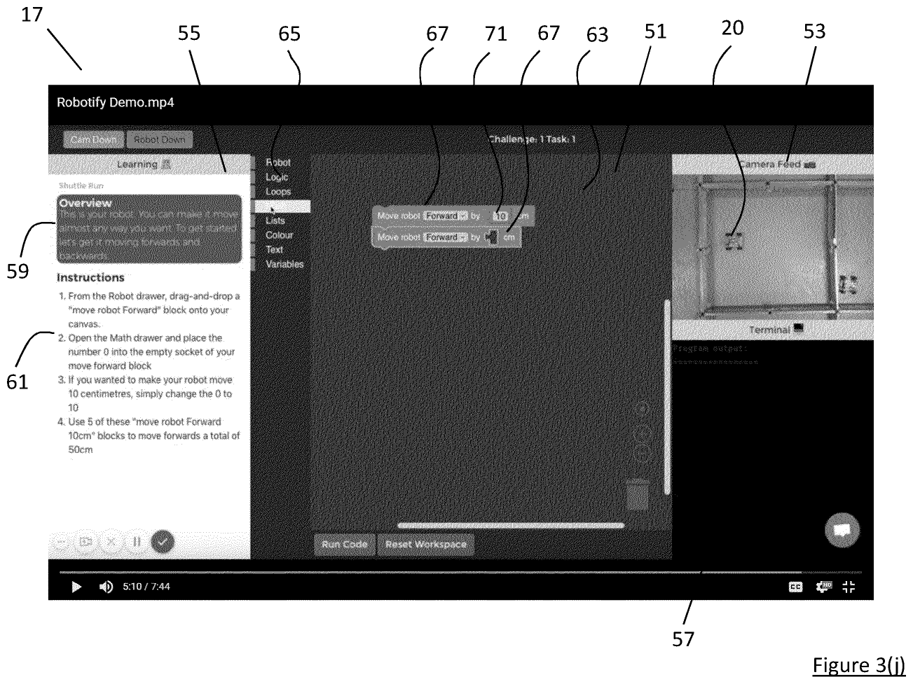

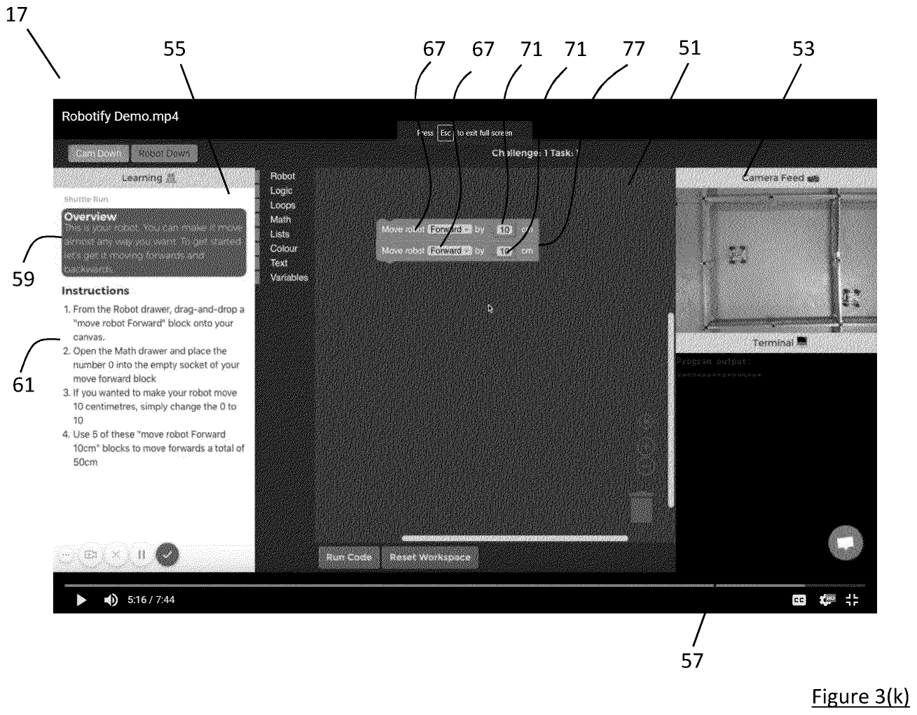

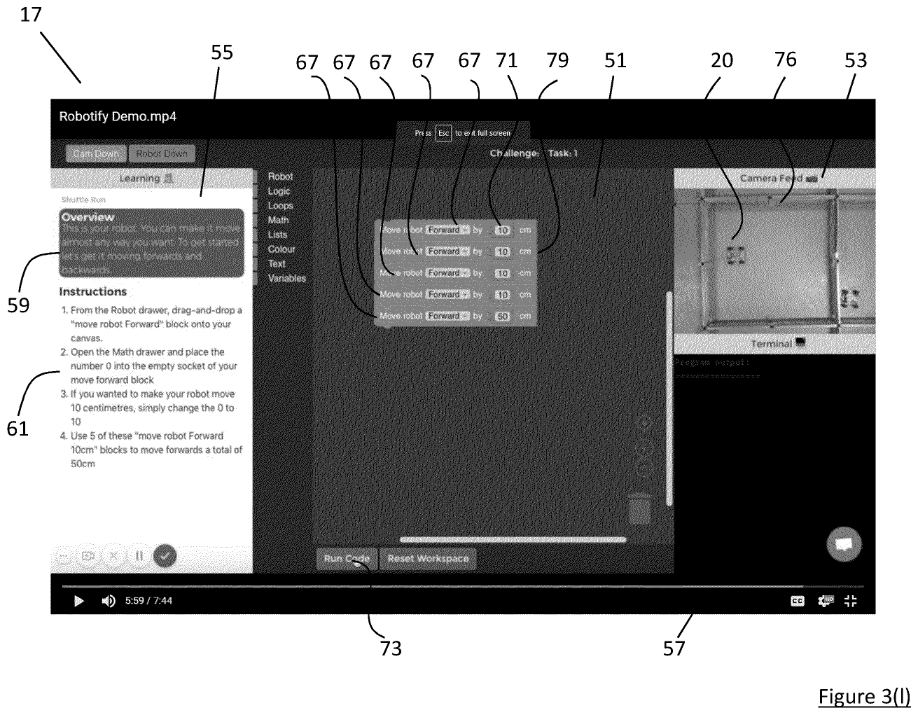

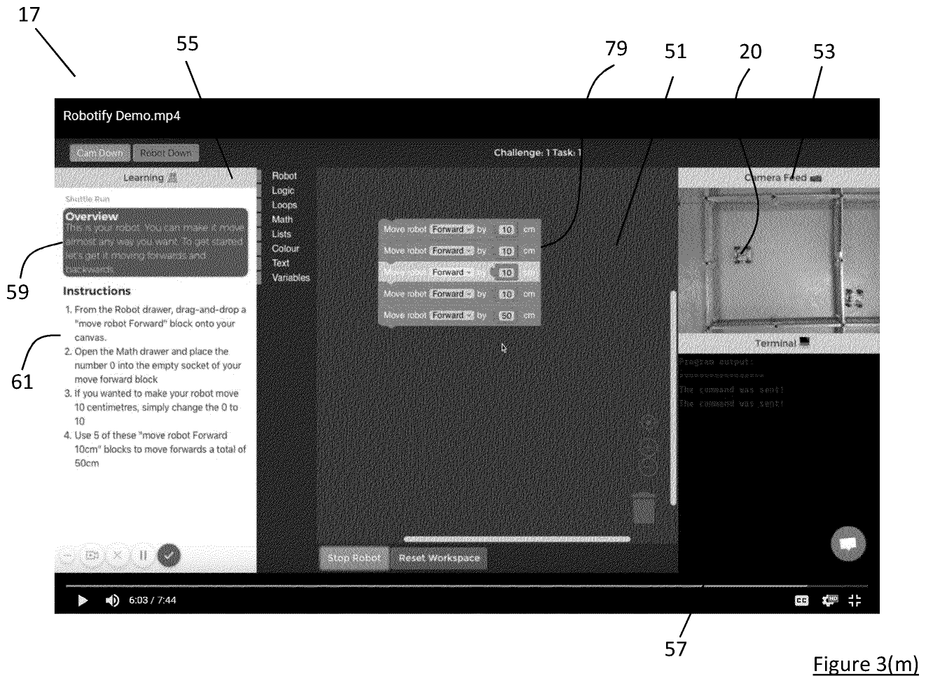

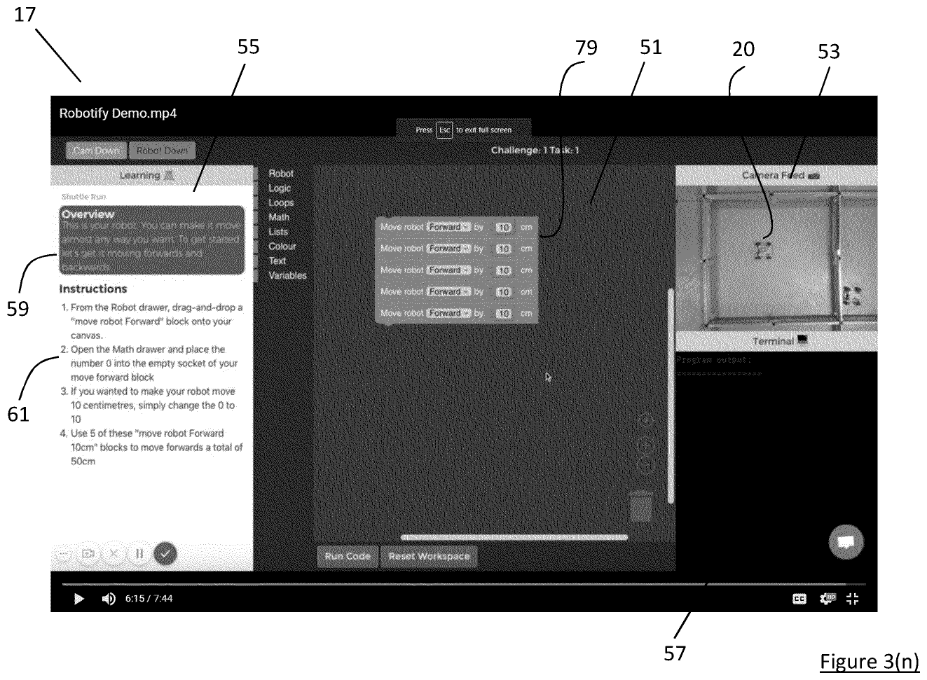

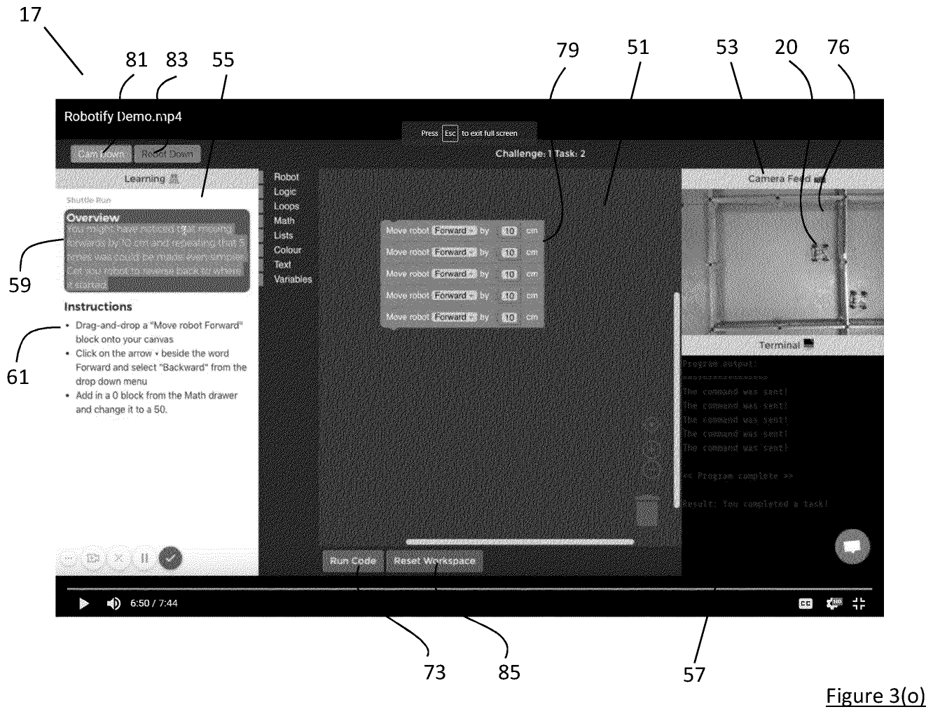

The remote computing devices 7 each have a communications module 13 for communication with the server 3 and the server 3 has a communication module 15 for communication with each of the remote computing devices. The remote computing devices 7 each have a user interface 17 having a plurality of panes (not shown), including a programming pane for receipt of control commands, and a video feed pane for displaying a video feed of a robot (which will be described in more detail below with reference to FIGS. 3(a) to 3(o)).

In use, the operators of the remote computing devices 7, using a web browser, contact the server 3 and the server 3 returns a web page user interface (as will be discussed below in relation to FIGS. 3(a) to 3(o) below) having a plurality of panes for display on the remote computing device. The web page further comprises a compiler integrated therein for compiling programming code and a library of videos of a robot performing manoeuvres (as will be discussed in more detail below). The web page is self sufficient in that once rendered on the remote computing device, all components necessary to implement the invention are contained on the remote computing device and further contact with the server is not necessary to implement the invention. The plurality of remote computing devices 7 are illustrated as personal computers however this is not intended to be limiting and the remote computing devices may be laptop computers, tablet computers, a phablet or a so-called smart phone if desired.

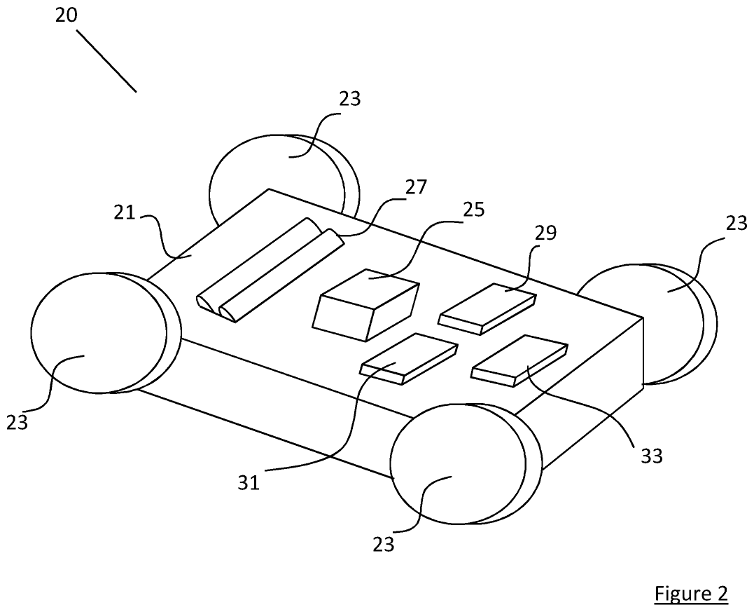

Referring now to FIG. 2, there is shown a diagrammatic representation of a robot 20 forming part of the system 1 according to the invention. The robot 20 comprises a wheeled chassis 21 having a plurality of wheels 23, an actuator operable to actuate the robot in response to control commands, in this case a motor 25 to drive the wheels, and a power supply, indicated by batteries 27. The robot 13 further comprises a communications module 29 for receiving control commands, a processor 31 for processing control commands, and a memory 33.

A video camera (not shown) is used to capture one or more video clips of the robot in operation. Ideally, the video camera is positioned directly above the robot when the robot is performing the manoeuvre. For example, a first video clip is captured of the robot moving forwards, a second video clip is captured of the robot moving backwards, a third video clip is captured of the robot turning clockwise, a fourth video clip is captured of the robot turning anti-clockwise and a fifth video clip is captured of the robot in a stationary position. The robot may have one or more light emitting diodes (LEDs) mounted thereon that will allow the video clip of the stationary robot to appear more realistic. The video camera is also used to capture a video of one or more pens in which the robot would otherwise be held. For example, the pen may be a 1.0 m by 1.0 m square pen walled in on all four sides. If desired, a number of markings on the floor of the pen may be provided, for example a maze layout or certain reference points. Again, the video camera is placed directly above the pen to take a plan view video from above of the pen. The video clips are stored as a library of video clips in memory 5 accessible by the server. This library of video clips may then be delivered to the remote computing device contained within the web page rendered on the remote computing device.

In use, a student operating a remote computing device 7 enters control commands using programming code into the web page user interface 17 on the remote computing device. The compiler in the web page compiles those commands and retrieves the appropriate video of the robot undertaking a manoeuvre from the video library delivered as part of the web page. The video of the robot undertaking the manoeuvre is then displayed in the video feed pane of the user interface. In this way, the student is shown a video of the robot undertaking a task that they programmed and they have for all intents and purposes, an experience in which they are programming a robot to perform certain actions. During periods of inactivity, for example, after a command has been executed, a default video of the robot will be shown which in this case may simply be a video of the robot in a stationary position in a loop, until the next command and the next video is called for display in the video feed pane. The videos are spliced together end to end so that it appears as though the client is looking at a live, continuous video feed of a robot.

As the robot's actions are effectively simulated, the school does not have to purchase the robot however the student still gets the benefit of seeing their programming operate on a robot and derives the benefits thereof. The maintenance and storage requirements for the school are obviated.

Referring now to FIGS. 3(a) to 3(o) inclusive, there are shown sample user interfaces, indicated generally by the reference numeral 17, for each of the plurality of remote computing devices 7. The user interface 17 comprises a plurality of panes, including a programming pane 51 for receipt of control commands, a video feed pane 53 for displaying the video of the robot, a tutorial pane 55 having user instructions for performing a task and a feedback pane 57 having an output comprising at least one of a compiled code and a commentary on the user-inputted control commands.

Referring first of all to FIG. 3(a), the tutorial pane 55 comprises a set of instructions to be completed by the student in order to complete a given task. These instructions may be specific to one or more students and may be prepared in advance by their teacher or the instructions may be provided as a generic pre-prepared exercise for students. Either way, the tutorial pane sets an exercise to be completed by the student. The tutorial pane includes an overview 59 of the exercise and what is trying to be achieved. In the present example, the overview 59 introduces the robot as the student's robot, informs the student that the robot may be moved around and to begin, the exercise will attempt to get the student to move the robot forwards and backwards. Below the overview 59 are instructions 61 which outline the steps that must be taken in order to complete the exercise. In the present example, this includes instructions on how the student can create the code to move the robot forward 50 centimeters (0.5 m), including retrieving blocks from different drawers of the programming pane 51 (steps 1 and 2), combining those blocks together (step 2 and 4), and editing those blocks (step 3).

Referring now to FIG. 3(b), step 1 of the instructions 61 recites the instruction “From the Robot drawer, drag and drop a “move robot Forward” block onto your canvas.” The programming pane 51 comprises a Visual Programming Language (VPL) Editor, in this case Blockly (Registered Trade Mark®) Editor. The Blockly Editor is a VPL editor that represents coding concepts as interlocking blocks. It provides a way of programming in a graphical form and it outputs syntactically correct code in the programming language of the user's choice.

The programming pane 51 comprises a canvas 63 and a plurality of drawers 65 in a list structure, including Robot drawer, Logic drawer, Loops drawer, Math drawer, Lists drawer, Colour drawer, Text drawer, and Variables drawer. The student uses a pointer device, such as a mouse, stylus or their finger if the user interface of the remote computing device is a touch screen, to select the robot drawer and clicks on the drawer in the known manner to “open” the drawer and expose the options of blocks in that drawer. In the present case, only one block is available in the robot drawer, a “move robot Forward” block 67. The user selects that block 67 in the known manner and “drags” the block onto the canvas 63 portion of the programming pane 51, as illustrated in FIG. 3(c). This is the beginning of their programming code. Step 1 of the instructions 61 is now complete.

Referring now to FIG. 3(d), the student moves on to step 2 of the instructions 61. Step 2 recites the instruction: “Open the Math drawer and place the number 0 into the empty socket of your move forward block”. It can be seen that there is an empty socket 69 in the block 67. The student selects the math drawer 65 from the list of drawers and again, in the example shown, only one block is displayed in the math drawer, the “number 0” block 71. The student selects the block 71 in the known manner and drags the block 71 over to the block 67 and hovers the block 71 above the socket 69 in block 67. The user then “drops” the block 71 and it will click into place in the socket 69 as illustrated in FIG. 3(e). It will be appreciated that the blocks 67, 71 and socket 69 are shaped so that the connections and correct positioning are intuitive. Step 2 is now complete.

Referring now to FIG. 3(f), the student moves on to step 3 of the instructions 61. Step 3 recites the instruction: “If you wanted to make the robot move 10 centimeters, simply change the 0 to 10”. The student selects the “0” of the block 71 and types “10” into the block 71 instead of “0”, thereby completing step 3. If at this stage, (before the exercise is complete) the student depressed the “Run Code” button 73, the VPL editor would run the code in the programming pane canvas 63. In this way, the code would be compiled, and a video of the background would be retrieved from the video library (if not already being displayed) along with a video of the robot moving forwards. The video of the robot moving forwards will be superimposed on the video of the background and a CSS transform is used to move the robot forward in the video feed pane by a distance corresponding to 10 centimeters (0.1 m). The code essentially reads, “move the robot forward by 10 centimeters”. Referring to FIG. 3(g), the code block 67 is highlighted to illustrate that the code is currently being run and the “run code” button 73 has changed to a “Stop Robot” button 75. Most importantly however, is the fact that the robot 13 in the video feed pane 53 can be seen to move forwards by 10 centimeters (0.10 m) inside its pen 76.

It will be understood that the “pen” 76 in which the “robot” is housed may be of the order of 1 square meter whereas the video feed pane on the user interface may be of the order of 10 square centimeters. Therefore, a movement of the video of the robot forwards of 1 centimeter on the video feed pane will correspond to a movement forward of 10 centimeters in a physical pen. Accordingly, the movements of the robot video on the video feed pane are scaled appropriately.

Once the code has been run, feedback is provided to the student in the feedback pane 57, as illustrated in FIG. 3(h). In the feedback pane 57, under the heading “Program output:” are the words: “The command was sent!” “<<Program Complete>>” and “Error. That is not quite right. Task incomplete.” In this way, the student knows that the instruction was successfully sent to the robot, that the program has finished and that they did not successfully complete the task. The task was to move the robot forward 50 centimeters (0.5 m), not only 10 centimeters (0.1 m) and therefore is incomplete. Furthermore, the “Stop Robot” button has transitioned back to “Run Code” button 73.

Referring now to FIG. 3(i), the student now attempts to complete the task by carrying out step 4. Step 4 recites the instruction: “Use 5 of these “move robot Forward 10 centimeters” blocks to move forwards a total of 50 centimeters”. In this way, the student is learning multiplication tables as well as programming and this is an ancillary benefit of the present invention. In addition to learning computer programming techniques, the student is also learning other subjects, in this case math. However, it is envisaged that other subjects and not simply math may be taught simultaneously to computer programming using the present invention.

In order to complete step 4, the student again selects the robot drawer 65 and selects the “move robot Forward” block 67 from the drawer, as illustrated in FIG. 3(i). The student then drags the “move robot Forward” block 67 over to the canvas 63 and drops the “move robot Forward” block 67 just beneath the “move robot Forward” block 67 populated with the math block 71 already on the canvas, as illustrated in FIG. 3(j). The two “move robot Forward” blocks 67 are then combined together to form a longer string of program code. It will be seen that the “move robot Forward” blocks 67 each have a dimple and a boss (in much the same way that two adjacent jigsaw pieces each have one part of a male and a female complementary connector) to illustrate how the two blocks can be combined together.

The student then accesses the math drawer 65 again, selects the “number 0” block 71 from the available list, drags the “number 0” block 71 over to the most recently placed “move robot Forward” block 67 and places the “number 0” block 71 into the socket 69 of the “move robot Forward” block 67. Thereafter, the student again types “10” into the editable portion of the “number 0” block 71. The resultant code segment 77 is as illustrated in FIG. 3(k). This is repeated a further three times to combine five “move robot Forward” blocks 67 together however with the last block, the student inadvertently inserts “50” instead of “10” into the “number 0” block 71, resulting in the code segment 79 as illustrated in FIG. 3(l). If the student then depresses the run code button 73, the Blockly® Editor will run the code and the robot 20 in the video feed pane 53 will be seen to move forward by 90 centimeters (0.9 m).

As the Blockly® Editor goes through each instruction in the code segment 79, the instruction in the code segment 79 being processed is highlighted, as illustrated in FIG. 3(m) and after the instruction has been processed, the feedback pane 57 is updated by placing under the heading “Program output:” the words: “The command was sent!” for each completed instruction. In FIG. 3(m), as the third instruction in the code segment 79 is being processed, the feedback pane 57 indicates that the first two instructions have been processed and the control command has been sent to the robot 20. Once the code has been compiled, the robot 20 would move 90 centimeters (0.9 m) forwards across the pod 76. An error message, as indicated previously, would be displayed to the operator as the robot had moved 90 centimeters (0.9 m) instead of 50 centimeters (0.5 m). If however, the student corrects their mistake and inserts “10” Instead of “50” into the final “number 0” block 71 of the bottom-most “move robot Forward” blocks 67 in the code segment 79 before clicking on the “Run Code” button 73, as illustrated in FIG. 3(n), the task will be completed successfully and the robot 13 will move forwards 50 centimeters (0.5 m) across the pod 76.

Referring now to FIG. 3(o), once the task has been completed successfully, the robot 20 in the video view pane will have moved a distance across the video feed pane 53 equivalent to a distance of 50 centimeters (0.5 m) across the pen 76, and the feedback pane 57 will have the words “The command was sent!” five times under the words “Program Output”, followed by “<<Program Complete>>” and then “Result: You completed the task!”. In addition, the words in the tutorial pane 55 will have changed to the next task. In this instance, the overview 59 will now read “You might have noticed that moving forwards by 10 cm and repeating that 5 times was could be made even simpler. Get your robot to reverse back to where it started.” The instructions 61 will now read “Drag-and-drop a “Move robot Forward” block onto your canvas. Click on the arrow ▾ beside the word “Forward” and select “Backward” from the drop down menu. Add in a 0 block from the Math drawer and change it to a 50.” In other words, the next task will be to generate the code to reverse the robot 50 centimeters (0.5 m). however, in this instance, it is shown that the step may be done in one step, with only two blocks 67, 71, as opposed to using 10 blocks. This is a good way of introducing the concept of variables and different ways of programming, resulting in the same solution, to the student.

In the screen shots 3(a) to 3(o) inclusive, there is further shown a number of buttons on the user interface including a “Cam Down” button 81, a “Robot Down” button 83 and a “Reset Workspace” button 85. If the videos from the library cannot be retrieved or if the robot is not responding, the user may click on the respective “Cam Down” button 81 or a “Robot Down” button 83 to alert the system administrator that there is a problem. If the user wishes to clear their canvas 63, they may do so by clicking on the “Reset Workspace” button 85.

The process by which an emulated robot is provided will now be described in more detail. The emulated robot is a video recording of an actual robot performing different movements/manoeuvres such as driving forwards, driving backwards, turning (clockwise and anti-clockwise) and staying stationary. The emulated pod or pen is a looping video recording of an empty pen/pod.

The procedure that is followed to produce these videos and make them browser friendly is as follows: First of all, a camera at a fixed height is used to record the images & videos as desired. Secondly, the robot is recorded on top of a green screen for easy post processing. Third, even lighting is used to allow for the bright green screen to be “keyed out” of the video. Fourth, the video is imported into Adobe® Premiere Pro®, and the “chroma key” tool is used to remove the green colours of the greens screen. Fifth, the robot video is overlayed on top of the pod video. Sixth, this video is compared to a video of the real robot in the pod and color grading is carried out as necessary for realism. Seventh, the video of the robot is exported separately with the “alpha channel”, this allows for the video to have a transparent background. Eighth, the video of the pod is edited and exported. Finally, both videos are exported as browser friendly .webm video formats. An external plugin is required to export a .webm video.

Once both of these videos (the video of the robot and the video of the background) are obtained, they can be added to the platform. The general process of emulating a robot experience is by overlaying the video of the processed emulated robot on top of the processed pod video. Javascript is then used to translate the emulated robot video across the emulated pod video in response to Blockly® blocks programming. According to one implementation of the present invention, using cascading style sheets (CSS), an invisible “border” is created and added onto the pen 76 video. The overlayed robot video is constrained to within this border and cannot drive past it. This is important as it makes the experience more realistic for the user. If the robot were to drive out of the pod video and across the screen, it would be obvious that the robot is not an actual physical robot viewed in real time.

By using the process described above for programming by the end user, the execution of a Blockly block will result in the actuation of a Javascript® function. The commands programmed by the user actuate a certain function and pass certain arguments to functions as illustrated in the code segment 1 below. In one implementation of the invention, CSS transforms are used to move the robot video around the screen, i.e. around the video of the pen 76 within the borders set inside the background pen video.

Code Segment 1:

if(typeof parseInt(arg) == ‘number’ && command == ‘5’ && parseInt (commandvalue)>0){

//Turn clockwise
startpos = rotate;
destpos = startpos+ parseInt(commandvalue);
console.log(“Turn clockwise Destination = “+destpos);
var id = setInterval(clockwise, rspeed);
function clockwise( ) {

if (destpos == rotate) {

clearInterval(id);
console.log(“hit”);
// every arrow
saved_moves = robot.style.transform;
//reset trany and rotate values
trany = 0;
rotate = 0;
return 1;

```
} else {
  // trany = trany+1;
  // robot.style,transform = saved_moves + ‘translateY(‘ + trany+’px)’;
  rotate = rotate+1;
  rotationCount++;
```

if(rotationCount>=360) rotationCount=rotationCount−360;

robot.style.transform = saved_moves + ‘rotate(‘+rotate+'deg)’;
console.log(“Current pos = “+rotate);
}

}

}

The code segment 1 of a function illustrated above is a demonstration of what the function looks like. An argument is passed, the function checks (in the nomenclature used for the instructions) if the argument is a number, if it is a number and the number is “5” then the command is considered to be a “turn” command. The number following the “5” is the amount for the robot to turn by. A loop begins which will start turning the robot until the destination angle is reached. This may entail providing a video of the wheels on one side of the robot rotating in one direction and the wheels on the opposite side of the robot counter-rotating. Once the destination angle is reached, if there is another command to execute, for example, move the robot forward, a video of the robot moving forward is then played as the robot video and a CSS transform will move the robot forward along the video feed pane by the amount determined by the command.

Instead of a CSS transform to move the video of the robot and borders in CSS, it is envisaged that the robot emulator could be built in Javascript using a Javascript Game Framework such as, but not limited to, Phaser®. Other methodologies will become apparent once the present disclosure is made.

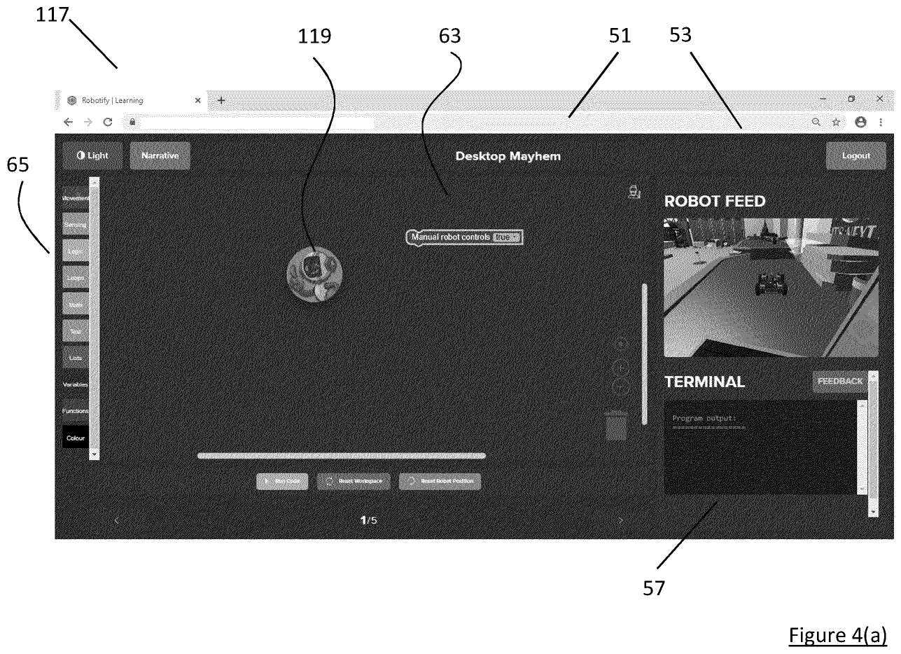

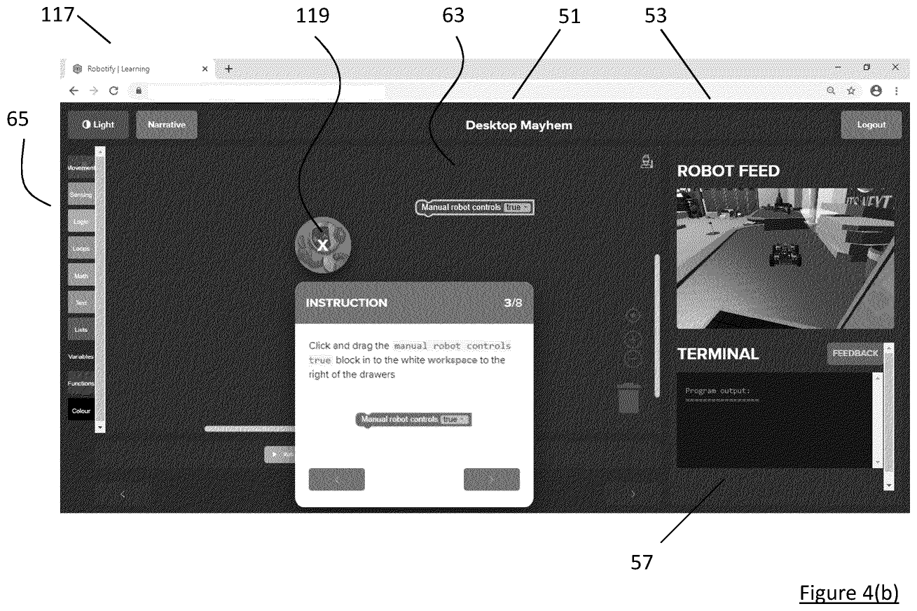

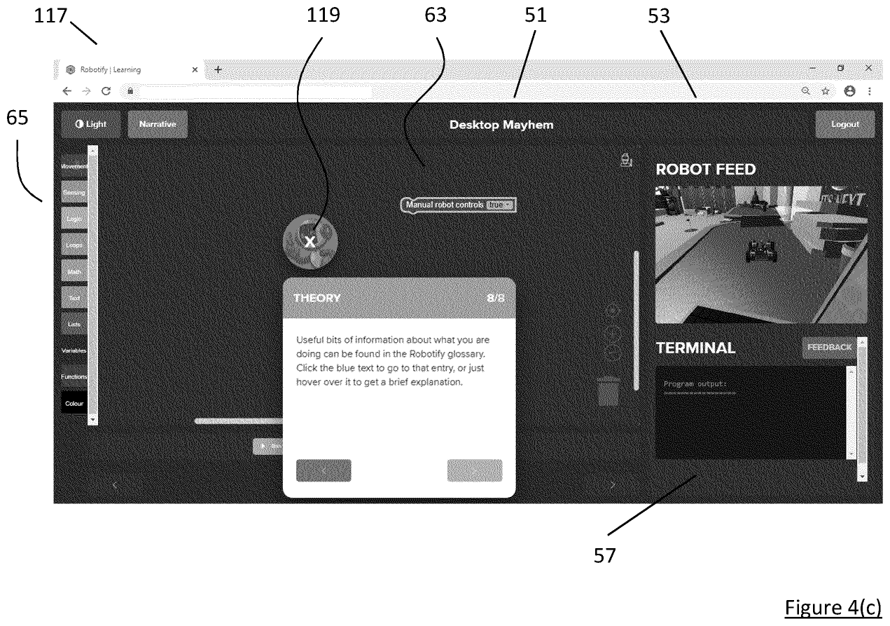

Referring now to FIGS. 4(a) to 4(c) inclusive, there is shown a particularly preferred embodiment of the present invention, where like parts have been given the same reference numerals as before. There is provided a user interface 117 of a second embodiment of the computer programming product according to the invention. The interface 117 comprises a programming pane 51 with a canvas 63 and a plurality of drawers 65 each containing one or more programming blocks as before. There is further provided a feedback (terminal) pane 57 for providing feedback and/or outputting compiled code and/or error messages.

Instead of having a dedicated tutorial pane with an overview and instructions in the dedicated tutorial pane as in the first embodiment, the overview and instructions are contained in a pop-up assistant 119. The pop-up assistant may be “clicked on” in the known manner to display, and conversely, to hide, the overview and instructions for the task. The overview and instructions may be presented in a single or a plurality of sequential messages that may be scrolled through using, a mouse or other pointing or like device for scrolling through a menu of items.

In FIG. 4(a), the pop-up assistant is shown minimized. In, order to maximize the pop-up assistant and view the instructions/overview, the pop-up assistant is “clicked on”. In FIG. 4(b), the pop-up assistant is shown maximized providing an instruction (page 3 of 8), instructing the student to carry out a particular task and in FIG. 4(c), the pop-up assistant is also shown maximized but this time providing theory (page 8 of 8) about the task being carried out. In order to minimize the pop-up assistant once more and hide from view the instructions/overview, the pop-up assistant is “clicked on”. The pop-up assistant 119 may be moved around the screen in the known manner for dragging objects across a screen. For example, the pop-up assistant may be moved by using a mouse to position a cursor, clicking on the icon of the pop-up assistant, keeping the mouse button depressed and using the mouse to drag the icon across the screen before releasing the mouse button when the icon is in the desired location.

Most significantly though, in the embodiment shown in FIGS. 4(a) to 4(c), the video feed pane 53 illustrates a robot emulator that is a three dimensional (3D) simulation of a robot 120 on a 3D simulation background. This is seen as a particularly preferred and advantageous aspect of the present invention. By having the robot and the background as 3D simulations, the structure and the content of both the robot and the background may be greatly enhanced. Indeed, the functionality of the robots may be significantly enhanced and the complexity of the background may be significantly enhanced. Richer, more enthralling environments may be created for the robot to operate in and the robot may be allowed to function in new and exciting ways. This will lead to a more engaging experience. At the same time, the flexibility for the providers of the offering will be greatly enhanced. In this context, the “video” in the video pane will be a 3D simulation.

By having a 3D simulation of the robot, it is not necessary to scan or record the movement of a robot. Instead, a physics engine and a JavaScript port may be used to provide the robot simulation. For example, the robot structure/appearance may be simulated in 3D modelling software and their behaviour may be simulated using the physics engine. In the present case, Ammo.js, a JavaScript port of the C++ library Bullet®, is used to simulate and model the behaviour of the robot.

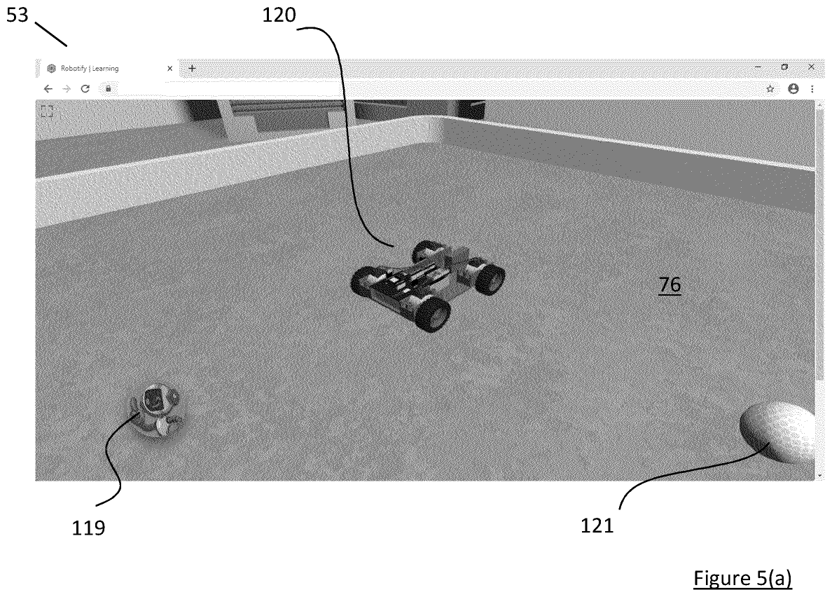

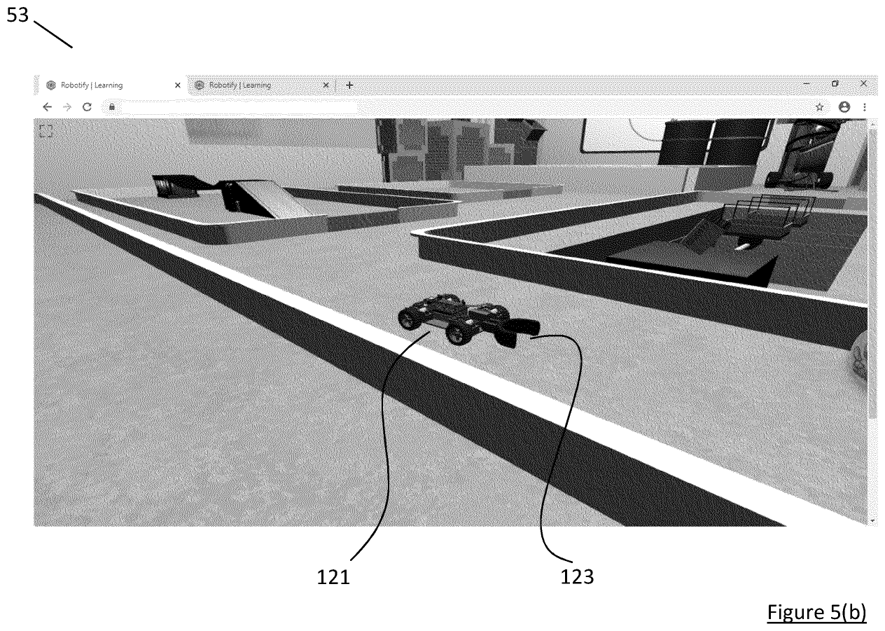

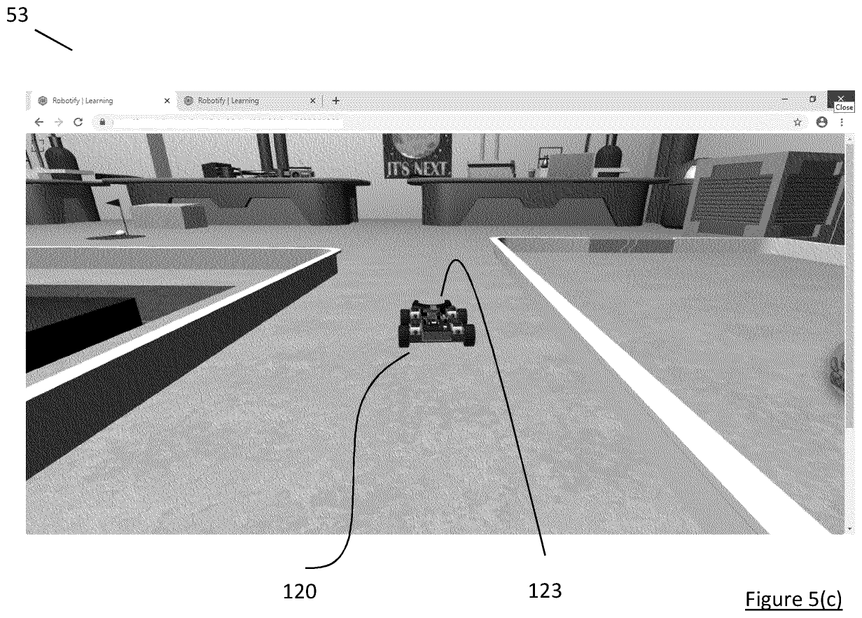

Referring now to FIGS. 5(a) to 5(c), there are shown some screen shots illustrating 3D robots 120 in the 3D backgrounds. In FIG. 5(a), the 30 robot is a standard wheeled robot in a pen however other objects have been introduced into the pen, in this case, a golf ball 121. The robot may be operable to interact with one or more of those objects. In addition, there is a view beyond the pen to pique the interest of the student and allowing the provider to enhance their offering by setting criteria for moving from one zone to another (for example, a user may only leave one zone (the pen) to explore another zone upon completion of a particular task).

Referring now to FIGS. 5(b) and 5(c), the robot 120 is equipped with a plough 123 that may assist the robot in moving objects to complete a particular task. More importantly though, it can be seen that the background has richer graphics and more components in the background than heretofore. This will provide a more engaging experience for the student and opens up a number of possibilities for the provider to create more expansive environments for the robot to operate in which will be more challenging and captivating for the student.

It will be understood that various modifications may be made to the computer program products and computer-implemented methods described above without departing from the scope of the claims. For example, in the embodiments shown and described, the computing devices 7 are described as remote. Indeed, this is to indicate that they are typically located remotely from the server 3. However, it could be considered that the computing devices 7 are local and the server and robot farm are remote from the computing devices. Furthermore, in the present example, the method and computer program product are described as being delivered through a web page. It will be understood however from the foregoing that once the web page is loaded on the remote computing device, all the computer program code necessary for implementing the invention is resident on the remote computing device. Therefore, it is envisaged that although the invention has been described in terms of a web page delivered solution, the invention could equally well be provided as a standalone program or “app”.

In the embodiments shown, the robots are relatively simple devices with a chassis and wheels driven by a motor. Other robots are envisaged with other functionality including a claw, magnet or scoop for picking up objects, robots with tracks, robots that resemble a crane that are fixed in position in the pen 76 but may rotate a boom about a mast and have a hook or other device that may move along the boom in a reciprocal fashion. The wheeled chassis robot may have more or less than 4 wheels or may have caterpillar tracks. The robot may be provided with one or more other components such as, but not limited to, one or more lights including, for example, one or more LEDs. Although the wheeled chassis robot is preferred as it is particularly simple to operate, what is important is in fact the fact that the robot may move in the pen 76 and be seen to move in response to user inputted commands in a programming language.

The pens 76, also referred to as pods, are walled pods and are relatively simple in configuration however other, more complex configurations are readily envisaged. For example, the pods may comprise a maze or other obstacle course for the robot to navigate. The pods may also be provided with lights or other components, The lights may also indicate whether or not the robot is functional, whether or not the robot is ready to receive instructions, and/or whether or not the robot is currently executing instructions or the like.

In the embodiments of the user interface 17 shown in FIGS. 3(a) to 3(o), four panes 51, 53, 55 and 57 are provided in the user interface however less than four panes may be shown simultaneously. Indeed, it is envisaged that two panes may be shown simultaneously, for example the programming pane 51 and the video feed pane 53 may be shown simultaneously. The relative sizes of the panes may differ from those shown and the video pane may be larger than shown and other panes may be larger or smaller than shown. It is envisaged that one or more panes may be minimized at will or when not in operation. For example, the feedback pane 57 may be in a pop-up window that only appears when the code is being processed and to provide feedback on the success or failure of the task.

In the embodiments shown, a VPL Editor, specifically a Blockly® Editor is used in the programming pane 51. The VPL Editor is particularly suitable for young children starting out programming. Other VPL Editors, such as, but not limited to, Scratch® may also be used instead of Blockly®. It is envisaged that other editors, that are not VPL based may be used as the student progresses in knowledge and experience. For instance, the programming pane may support textual programming languages as well as or instead of the VPL.

In the embodiments described, only a small subset of the available blocks are illustrated. It will be understood that each of the drawers 65 may contain more than one block and indeed probably will contain more than one block. It is envisaged that the available blocks may be limited by a teacher or other course creator to prevent confusion. In other cases, such as for a final test or for advanced users, the entire library of blocks may be made available. The blocks may be custom built blocks if desired that may be provided to teach a certain concept or programming technique.

In the embodiments described the server may be a Python® server or other web server capable of handling communications to and from the remote computing devices. In the embodiments described, the server is described as having a communication module to handle all of these communications however this communication module may comprise a number of components, each of which may handle a different communication channel.

The processing and compiling of the program code is typically performed locally on the remote computing device however if desired it could be performed remotely on the server. It is envisaged that it would be preferable to have the processing and compiling of code done on the remote computing device. This will spread the load of the processing requirement and will reduce the data that must be transmitted to the server. It is envisaged that the user interface will comprise a browser window that may have-embedded therein a compiler to compile the code.

It will be understood that the present invention may be used by a number of disparate users in disparate locations. It is envisaged that the users will not simply be in a classroom environment, home schoolers and recreational users or individuals wishing to learn programming for other purposes may use the system from time to time. This could be at any time of day, in any place around the world. The server will also provide a booking engine to allow the computer program product to be pre-booked and to allocate access to a user at a given time.

In the embodiments shown in FIGS. 3(a) to 3(o), only one robot is shown in each pen 76. It is envisaged however that more than one robot may be provided in a single pen. For example, the user device may have the ability to operate multiple robots in the one pen in order to make the robots work together to complete a task. Equally well, two or more robots may be provided in the pods and different users operating different remote computing devices may each operate one of the robots in the pen. In this case, competitions or “robot wars” may be set to pit the wits of one programmer up against those of another programmer.

It will be understood that various parts of the present invention are performed in hardware and other parts of the invention may be performed either in hardware and/or software. It will be understood that the method steps and various components of the present invention will be performed largely in software and therefore the present invention extends also to computer programs, on or in a carrier, comprising program instructions for causing a computer or a processor to carry out steps of the method or provide functional components for carrying out those steps. The computer program may be in source code format, object code format or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit. In certain circumstances, a transmissible carrier such as a carrier signal when transmitted either wirelessly and/or through wire and/or cable could carry the computer program in which cases the wire and/or cable constitute the carrier.

It will be further understood that the present invention may be performed on two, three or more devices with certain parts of the invention being performed by one device and other parts of the invention being performed by another device. The devices may be connected together over a communications network. The present invention and claims are intended to also cover those instances where the system is operated across two or more devices or pieces of apparatus located in one or more locations.

In this specification the terms “comprise, comprises, comprised and comprising” and the terms “include, includes, included and including” are all deemed totally interchangeable and should be afforded the widest possible interpretation.

The invention is not limited to the embodiments hereinbefore described but may be varied in both construction and detail within the scope of the appended claims.

1) A computer program product for teaching computer programming comprising program code for rendering a user interface on a user computing device, the user interface comprising a programming pane, a compiler and a video feed pane;
the programming pane being operable to receive control commands from a user;
the compiler being operable to compile the control commands received in the programming pane and pass those compiled control commands to the video feed pane; and
the video feed pane comprising a robot emulator and a background, both for display in the video feed pane.

2) The computer program product as claimed in claim 1 in which the robot emulator for display in the video feed pane comprises a three-dimensional (3D) simulation of the robot.

3) The computer program product as claimed in claim 1 in which the background for display in the video feed pane comprises a three-dimensional (3D) simulation of the background.

4) The computer program product as claimed in claim 2 in which the robot emulator uses a JavaScript port and a physics engine.

5) The computer program product as claimed in claim 4 in which the JavaScript port is Ammo.js and the physics engine is Bullet physics engine.

6) The computer program product as claimed in claim 1 in which the video feed pane comprising a robot emulator having at least one video of a robot performing a manoeuvre, and the background, both for display in the video feed pane; the robot emulator being operable to execute the compiled control commands by displaying the background in the video pane, playing the video of the robot performing the manoeuvre on the background, and moving the video of the robot relative to the background in the video feed pane.

7) The computer program product as claimed in claim 6 in which the robot emulator comprises a library of videos of a robot performing a plurality of disparate manoeuvres.

8) The computer program product as claimed in claim 7 in which the library of videos comprises: (i) a video of the robot moving forwards; (ii) a video of the robot moving backwards; (iii) a video of the robot stationary; (iv) a video of the (20) robot turning clockwise; and (v) a video of the robot turning counter-clockwise.

9) The computer program product as claimed in claim 6 in which the background is a video of a background and the robot emulator is operable to superimpose the video of the robot performing a manoeuvre on top of the video of the background in the video pane.

10) The computer program product as claimed in claim 6 in which the background is provided with a border operable to contain the video of the robot therein.

11) The computer program product as claimed in claim 6 in which the robot emulator uses a transform operation to move the video of the robot relative to the background.

12) The computer program product as claimed in claim 11 in which the robot emulator uses a CSS transform to move the robot video relative to the background.

13) The computer program product as claimed in claim 1 in which the user interface comprises a web page.

14) computer program product as claimed in claim 1 in which the user interface comprises a tutorial pane, the tutorial pane having user instructions for performing a task.

15) The computer program product as claimed in claim 1 in which the user interface comprises a feedback pane, the feedback pane having an output comprising at least one of a compiled code and a commentary on the user-inputted control commands.

16) The computer program product as claimed in claim 1 in which the programming pane comprises a Visual Programming Language (VPL) Editor.

17) The computer program product as claimed in claim 11 in which the programming pane comprises a Blockly Editor.

18) The computer program product as claimed in claim 1 in which the robot comprises a vehicle having a motor and at least two wheels driven by the motor.

19) A computer implemented method of teaching computer programming comprising the steps of:
providing, on a user computing device a user interface having a plurality of panes including a programming pane and a video feed pane, the video feed pane comprising a robot emulator and a background, both for display in the video feed pane;
receiving, in the programming pane of the user interface of the user computing device a control command;
compiling the control command;
passing the compiled control command to the robot emulator;
the robot emulator executing the compiled control command by rendering the background and a robot performing a manoeuvre in front of the background in the video feed pane.

20) The computer implemented method as claimed in claim 19 in which the robot emulator for display in the video feed pane comprises a three-dimensional (3D) simulation of the robot.

21) The computer implemented method as claimed in claim 19 in which the background for display in the video feed pane comprises a three-dimensional (3D) simulation of the background.

22) The computer implemented method as claimed in claim 19 in which the step of rendering the background and the robot comprises using a JavaScript port and a physics engine to render the background and the robot.

23) The computer implemented method as claimed in claim 22 in which the JavaScript port is Ammo.js and the physics engine is Bullet physics engine.

24) The computer implemented method as claimed in claim 19 in which the robot emulator comprises at least one video of a robot performing a manoeuvre, and in which the step of the robot emulator executing the compiled control command comprises the step of the robot emulator rendering a video of a robot performing a manoeuvre in front of the background in the video feed pane and moving the video of the robot performing a manoeuvre relative to the background in the video feed pane.

25) The computer implemented method as claimed in claim 24 in which the method comprises the intermediate step of the robot emulator selecting one of a plurality of videos of a robot performing a manoeuvre from a library of videos of the robot performing different manoeuvres.

26) The computer implemented method as claimed in claim 25 in which the intermediate step of the robot emulator selecting one of a plurality of videos of a robot performing a manoeuvre from a library of videos of the robot performing different manoeuvres comprises selecting one of (i) a video of the robot moving forwards; (ii) a video of the robot moving backwards; (iii) a video of the robot stationary; (iv) a video of the robot turning clockwise; and (v) a video of the robot turning counter-clockwise.

27) The computer implemented method as claimed in claim 24 in which the background is a video of a background and the method comprises the step of the robot emulator superimposing the video of the robot performing a manoeuvre on top of the video of the background in the video pane.

28) The computer implemented method as claimed in claim 24 in which the method comprises the step of rendering a background and a default video of a robot performing a manoeuvre in front of the background in the video feed pane while waiting for a control command.

29) The computer implemented method as claimed in claim 24 in which the method comprises the initial step of defining a border for the background to delimit the movement of the video of the robot performing a manoeuvre in the video feed pane.

30) The computer implemented method as claimed in claim 24 in which the step of moving the video of the robot performing a manoeuvre relative to the background in the video feed pane comprises using a transform operation to move the robot video relative to the background.

31) The computer implemented method of teaching computer programming as claimed in claim 29 in which the step of providing a user interface comprises providing a web page to the user computing device.

32) The computer implemented method of teaching computer programming as claimed in claim 29 in which the step of: receiving, in the programming pane of the user interface of the user computing device a control command further comprises receiving a control command in a VPL.

33) The computer implemented method of teaching computer programming as claimed in claim 19 in which the user interface comprises a tutorial pane and the method comprising the additional step of providing user instructions in the tutorial pane of the user interface.

34) The computer implemented method of teaching computer programming as claimed in claim 19 in which the user interface comprises a feedback pane and the method comprising the additional step of providing at least one of compiled code and commentary on the user inputted control commands in the feedback pane of the user interface.
